(19) United States
(12) Patent Application Publication
(10) Pub. No.: US 2015/0261368 A1
(43) Pub. Date: Sep. 17, 2015

(54) TOUCH PANEL AND METHOD OF ATTACHING THE SAME

(71) Applicant: HENGHAO TECHNOLOGY CO., LTD., Hsinchu County (TW)

(72) Inventor: Ting-Chieh CHEN, Hsinchu County (TW)

(21) Appl. No.: 14/461,369

(22) Filed: Aug. 16, 2014

(30) Foreign Application Priority Data
Mar. 13, 2014 (TW) 103109188

(51) Int. Cl. G06F 3/041

(52) U.S. Cl. CPC G06F 3/0412

(57) ABSTRACT

A touch apparatus is disclosed. The touch apparatus includes a touch panel; an anti-shatter film having a first surface and a second surface opposite to the first surface, wherein the first surface is attached below the touch panel; a display panel having a third surface; and a pressure sensitive adhesive disposed on one of the second surface and the third surface, wherein the display panel is attached to the second surface through the pressure sensitive adhesive.

### CROSS-REFERENCE TO RELATED APPLICATION AND CLAIM OF PRIORITY

This application claims the benefit of the Taiwan Patent Application No. 103109188, filed on Mar. 13, 2014, at the Taiwan Intellectual Property Office, the disclosures of which are incorporated herein in their entirety by reference.

### FIELD OF THE INVENTION

The present invention relates to a panel. In particular, the present invention relates to a touch panel and a method of attaching the same.

### BACKGROUND OF THE INVENTION

Referring to FIG. 1 regarding the attachment of a touch panel 11 to a display panel 12, such as an LCD panel, to form a panel assembly, most of the prior art makes the attachment by printing a seal 13 between the touch panel 11 and the display panel 12. In such a condition, there is an air layer 14, which is also called a gap, between the touch panel 11 and the display panel 12. In order to prevent users from being injured by a broken touch panel 11, a anti-shatter film 15 is usually attached to a bottom side of the touch panel 11. The utilization of the seal 13 to attach the touch panel 11 and the display panel 12 has been widely used for years and the relevant materials and the manufacturing processes are definitely mature. However, a loss of light intensity is increased due to the fact that the light must be transmitted though the display panel 12, then through the touch panel 11, and additionally transmitted through an air layer 14 existing between the touch panel 11 and the display panel 12. In other words, the overall transmission of the touch panel 11 and the display panel is reduced, and consequently the visual performance of the panels is adversely affected by the air layer 14.

Referring to FIG. 2 regarding another attachment of the touch panel 11 and the display panel 12, such as an LCD panel, FIG. 2 shows another prior art which uses an optical clear adhesive (OCA) or an optical clear resin (OCR) directly adhering to the entire surfaces between the touch panel 11 and the display panel 12. This type of the structure overcomes the deficiency caused by the air layer 14 between the touch panel 11 and the display panel 12 if a seal is printed for the attachment of the panels, and accordingly provides better visual performance to users. In addition, users will not be easily injured if the touch panel 11 is broken because the attachment of the touch panel 11 and the display panel 12 is done on the entire surfaces so that the broken pieces of the touch panel 11 will still adhere to the surface of the display panel 12. However, from the point of view of the manufacturing process, the touch panel 11 is attached to the display panel 12 and the entire surfaces could easily encounter an appearance defect, such as when a bubble occurs during the attachment, and so the process yield rate is not high and therefore mass production is ineffective. In addition, because the technical threshold to rework the defective panels is high, the material loss and the reworking cost will increase accordingly.

In order to overcome the drawbacks in the prior art, a touch panel and a method of using the same are disclosed. The particular design in the present invention not only solves the problems described above, but also is easy to implement. Thus, the present invention has utility for the industry.

### SUMMARY OF THE INVENTION

In accordance with an aspect of the present invention, a touch apparatus is disclosed. The touch apparatus includes a touch panel; an anti-shatter film having a first surface and a second surface opposite to the first surface, wherein the first surface is attached below the touch panel; a display panel having a third surface; and a pressure sensitive adhesive disposed on one of the second surface and the third surface, wherein the display panel is attached to the second surface through the pressure sensitive adhesive.

In accordance with another aspect of the present invention, a method for attaching a panel is disclosed. The method includes steps of providing a touch panel; providing a functional film having a first surface and a second surface; attaching the first surface of the functional film to the touch panel; disposing a first pressure sensitive adhesive on the second surface; and attaching a display panel to the second surface through the pressure sensitive adhesive.

In accordance with a further aspect of the present invention, a touch panel assembly is disclosed. The touch panel assembly includes a touch panel; a display panel; a first adhesive layer attached to the touch panel and the display panel; and a functional film having a first surface and a second surface respectively attached to the touch panel and the display panel.

In accordance with further another aspect of the present invention, a panel assembly is disclosed. The panel assembly includes a first panel; a second panel; and a pressure sensitive adhesive attaching together the first panel and the second panel.

In accordance with further another aspect of the present invention, a functional film is disclosed. The functional film includes a substrate having a first surface and a second surface opposite to the first surface; and a first pressure sensitive adhesive having a first adhesion strength and attached to the first surface.

The above objectives and advantages of the present invention will become more readily apparent to those ordinarily skilled in the art after reviewing the following detailed descriptions and accompanying drawings.

### BRIEF DESCRIPTION OF THE DRAWINGS

FIG. 1 is a diagram showing a cross-section of a touch panel according to a prior art;

FIG. 2 is a diagram showing a cross-section of a touch panel according to another prior art;

FIGS. 3A to 3E are diagrams showing the cross-sections of panel assemblies according to embodiments of the present invention;

FIGS. 4 and 5 are diagrams showing cross-sections of panel assemblies according to another embodiments of the present invention;

FIG. 6 is a diagram showing a cross-section of a functional film according to an embodiment of the present invention;

FIG. 7 is a diagram showing a cross-section of a functional film according to another embodiment of the present invention;

FIG. 8 is a diagram showing a cross-section of a panel assembly according to an embodiment of the present invention; and

FIG. 9 is a diagram showing a cross-section of a panel assembly according to another embodiment of the present invention.

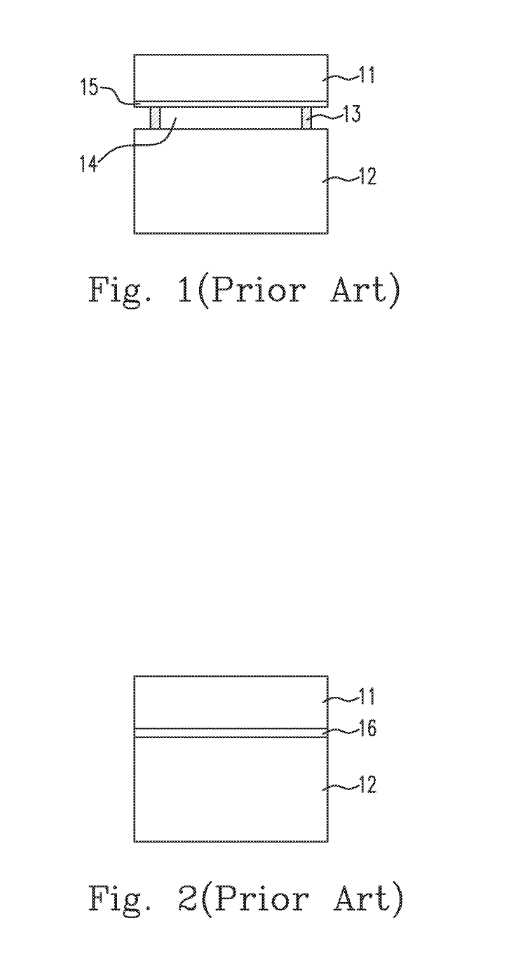

### DETAILED DESCRIPTION OF THE PREFERRED EMBODIMENT

The present invention will now be described more specifically with reference to the following embodiments. It is to be noted that the following descriptions of the preferred embodiments of this invention are presented herein for the purposes of illustration and description only; they are not intended to be exhaustive or to be limited to the precise form disclosed.

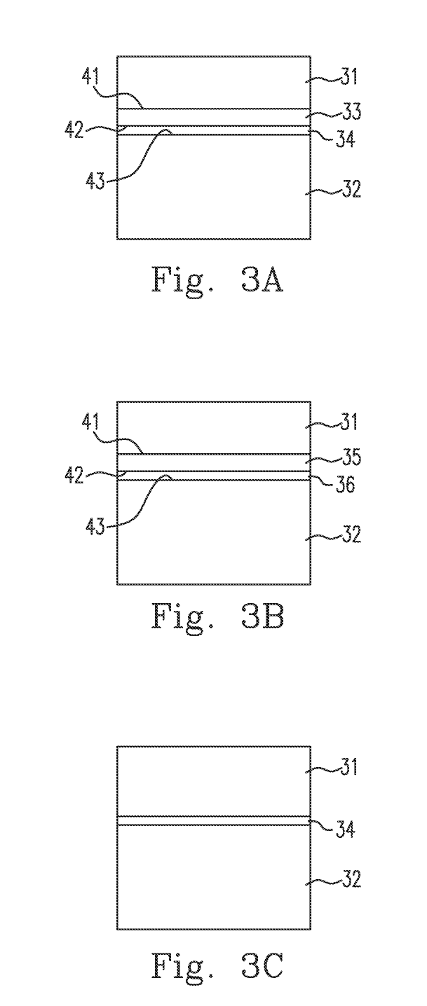

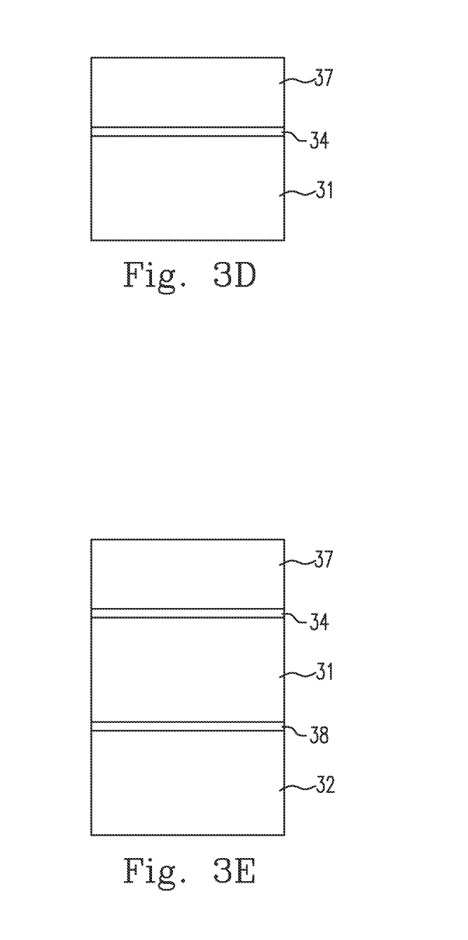

The present invention has advantages over the prior art, and simultaneously overcomes the shortcomings in the prior art. According to an embodiment of the present invention, as shown in FIG. 3A, an anti-shatter film 33 having a first surface 41 and a second surface 42 is disposed between a touch panel 31 and a display panel 32 having a third surface, wherein the first surface 41 of the anti-shatter film 33 is attached to the bottom side of the touch panel 31 while a surface adhesive with excellent performance of preventing the occurrence of bubbles during the panel attachment process, such as a pressure sensitive adhesive 34, is disposed on and is attached to the second surface 42 of the anti-shatter film 33. The material of the pressure sensitive adhesive 34 is one selected from a group consisting of polyurethane (PU), silicone, acrylic and a combination thereof. The anti-shatter film 33 is attached to the third surface of the display panel 32 through the pressure sensitive adhesive 34, and the touch panel 31 is attached to the display panel 32 through the anti-shatter film 33. Consequently, the present invention provides not only an anti-shatter function, but also a solution, without the existence of the air layer 14, to improve the problem of the poor visual performance encountered in the prior art. In addition, the yield rate of the panels attached with the entire surfaces between panels is increased, and the difficulty of reworking the defective panel assemblies is also improved by the present invention.

As to the visual performance mentioned above, the results of the improvement by the present invention and the data of the prior art are compared in Table 1.

TABLE 1

| | Display panel only | Prior art | The present |
|---|---|---|---|
| Sample | (without touch panel) | (with the air layer) | invention |
| Transmission | 100% | 86% | 98.5% |
| | (as a reference) | | |

It can be seen from the transmission data measured and shown in Table 1 that, using the display panel 11 or 32 without being attached to the touch panel 31 as a reference of 100% transmission, the overall transmission of the panel assembly using the present invention, after the display panel 32 is directly attached to the touch panel 31, increases to 98.5%, which means the transmission loss is merely 1.5%, while the transmission loss of the panel assembly using the prior art increases to 14% because of the air layer 14 existing between the display panel 12 and the touch panel 11.

Sometimes, it is necessary to rework a defective panel assembly having a poor attachment quality caused by the attachment of the touch panel 31 and the display panel 32. Referring to FIGS. 3A and 3B which are diagrams showing other embodiments of the present invention, only simple steps are required to perform a reworking process as follows: (1) removing the anti-shatter film 33 and the pressure sensitive adhesive 34 between the touch panel 31 and the display panel 32, (2) re-adhering an anti-shatter film 35 and a pressure sensitive adhesive 36 to the touch panel 31, and (3) attaching the touch panel 31 to the display panel 32 through the pressure sensitive adhesive 36. The steps of removing the anti-shatter film 33 and the pressure sensitive adhesive 34 between the touch panel 31 and the display panel 32 include separating the pressure sensitive adhesive 34 from the third surface 43 of the display panel 32, removing the anti-shatter film 33 and the pressure sensitive adhesive 34 to recover the touch panel 31, and using a new anti-shatter film 35 and a new pressure sensitive adhesive 36 to adhere to the touch panel 31.

FIG. 3C is a diagram showing a cross-section of a touch panel according to another embodiment of the present invention. As shown in FIG. 3C, the present invention discloses another structure of the panel attachment. If the anti-shatter film 33 is not required in the panel assembly, the touch panel 31 can be directly attached to the display panel 32 by the pressure sensitive adhesive 34 disposed therebetween. The pressure sensitive adhesive 34 is used as the material for panel attachment to replaces the prior material of the OCA or OCR. As mentioned above, using the pressure sensitive adhesive 34 not only improves the problems of the poor visual performance in the prior art, but also improves the yield rate of the panels attached with the entire surfaces and reduces the difficulties of reworking.

The pressure sensitive adhesive 34 can be applied to various panel assemblies. FIGS. 3D and 3E are diagrams showing the cross-sections of the touch panels according to other embodiments of the present invention. As shown in FIG. 3D, the present invention discloses another structure of the panel attachment. If the anti-shatter film 33 is not required in the panel assembly, the touch panel 31 can be directly attached to a protection panel 37, also called a cover glass or a cover lens, using the pressure sensitive adhesive 34 disposed therebetween. As further shown in FIG. 3E, the touch panel 31 is directly attached to the protection panel 37 through the pressure sensitive adhesive 34 disposed therebetween at first, and then the touch panel 31 is attached to the display panel 32 through the pressure sensitive adhesive 38 disposed therebetween. Alternatively, the touch panel 31 is directly attached to the display panel 32 through the pressure sensitive adhesive 38 disposed therebetween at first, and then the touch panel 31 is attached to the protection panel 37 through the pressure sensitive adhesive 34 disposed therebetween. Regardless of which alternative sequence of the panel attachment different from the one mentioned above is adopted, the structure of the panel assembly shown in FIG. 3E can be obtained.

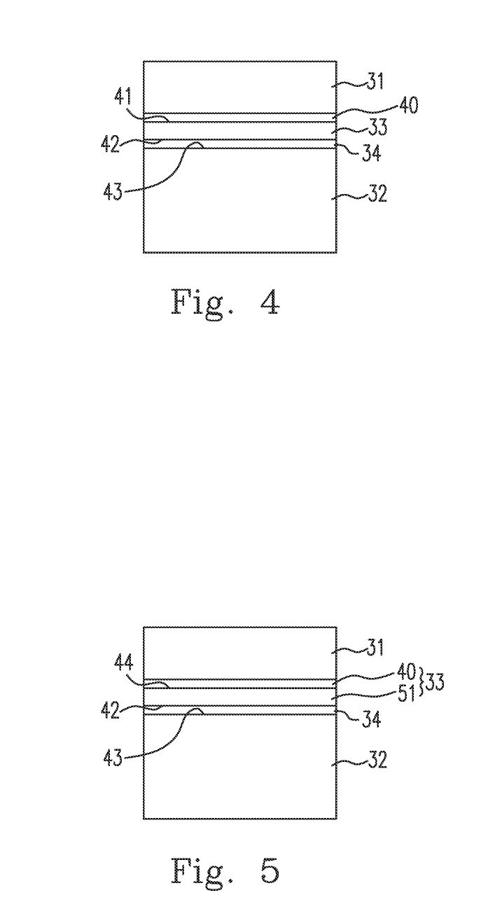

FIG. 4 is a diagram showing a cross-section of a touch panel according to another embodiment of the present invention. As shown in FIG. 4, the anti-shatter film 33 does not include an OCR 40 on the first surface 41 thereof. In such a situation, before attaching the touch panel 31 to the display panel 32, the OCR 40 should be coated on the bottom side of the touch panel 31, and the pressure sensitive adhesive 34 should be adhered to the second surface 42 of the anti-shatter film 33 or to the third surface 43 of the display panel 32. Through the pressure sensitive adhesive 34, the second surface 42 of the anti-shatter film 33 is attached to the display panel 32, and then through the OCR 40, the first surface 41 of the anti-shatter film 33 is attached to the bottom side of the touch panel 31.

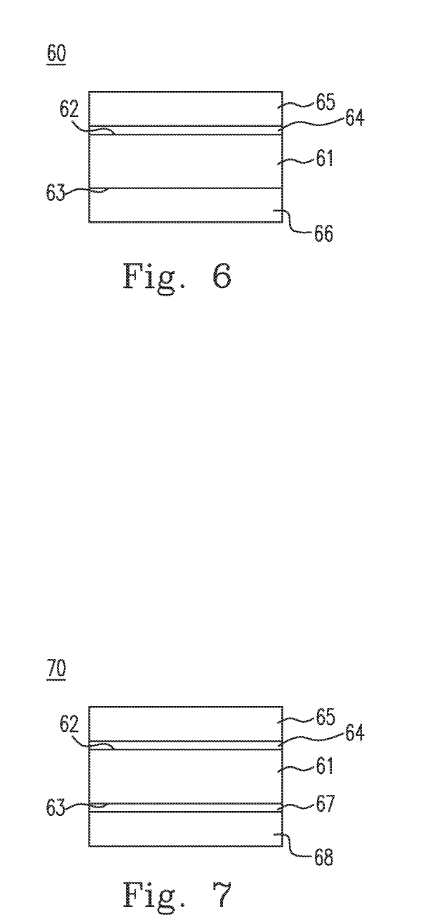

FIG. 5 is a diagram showing a cross-section of a touch panel according to another embodiment of the present invention. As shown in FIG. 5, the anti-shatter film 33 includes a plastic substrate 51 having a fourth surface 44 and the OCR 40 disposed on the fourth surface 44. In a real application, users can buy this kind of anti-shatter film 33, and do not need an additional coating process to coat the OCR 40 on the touch panel 31. The user only needs to attach the anti-shatter film 33 having the OCR 40 to the bottom side of the touch panel 31. In addition, the pressure sensitive adhesive 34 can be adhered to the third surface of the display panel 32 so that the display panel 32 can be attached to the touch panel 31 through the anti-shatter film 33.

FIGS. 6 and 7 are diagrams showing the functional films for various panel assemblies according to other embodiments of the present invention. As shown in FIG. 6, a functional film 60 includes a plastic substrate 61 having a fifth surface 62 and a sixth surface 63, wherein the fifth surface 62 is attached to a pressure sensitive adhesive 64, the pressure sensitive adhesive 64 is further attached to a release film 65, and the sixth surface 63 is attached to a protective film 66. Therefore, the functional film 60 having the pressure adhesive film 64 adhered to one surface of the plastic substrate 61 is formed accordingly. In addition, as shown in FIG. 7, a functional film 70 is a variation arising from the preceding functional film 60. The functional film 70 differs from the functional film 60 in that the sixth surface 63 is additionally attached to another pressure sensitive adhesive 67, and the pressure sensitive adhesive 67 is attached to a protective film 68. Therefore, the functional film 70 having the pressure adhesive films 64 and 67 on both surfaces of the plastic substrate 61 is formed accordingly. The functional film 70 can be used as a functional film having an anti-shatter function attached to the two panels, such as the touch panel 31 and the display panel 32 or the like.

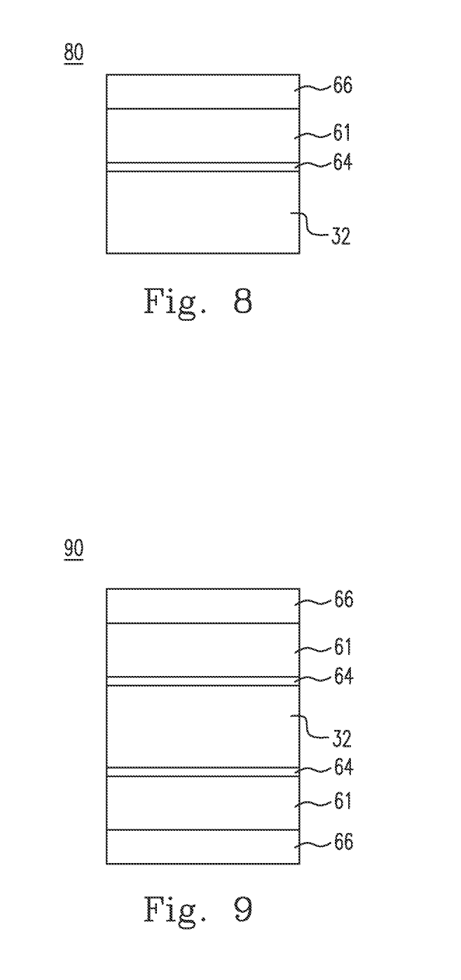

As shown in FIG. 8, a panel assembly 80 is formed from the display panel 32 and the functional film 60 shown in FIG. 6 attached thereto. The release film 65 of the functional film 60 is peeled off before being attached to the functional film 60 on the display panel 32. The plastic substrate 61 having the protective film 66 is attached to the top side of the display panel 32 through the pressure sensitive adhesive 64. The aforementioned functional film 60 can be one selected from a group consisting of a polarizer, an anti-reflection film (AR film), or an anti-glare film (AG film), which is attached to a surface of a panel. If the material of the plastic substrate 61 is polyester (PET), the functional film 60 is one of the AR film and the AG film. If the material of the plastic substrate 61 is a cycloolefin polymer (COP), the functional film 60 is an optical film.

As further shown in FIG. 9, a panel assembly 90 is formed from the display panel 32 having a top side as well as a bottom side and the two functional films 60 shown in FIG. 6 attached thereto. The release films 65 of the two functional films 60 are peeled off in advance. The two plastic substrates 61 having the protective films 66 are attached to the top side and the bottom side of the display panel 32 through the two pressure sensitive adhesives 64. If the material of the plastic substrate 61 is triacetyl cellulose (TAC), the functional film 60 is a polarizer.

### Embodiments

1. A touch apparatus, including: a touch panel; an anti-shatter film having a first surface and a second surface opposite to the first surface, wherein the first surface is attached below the touch panel; a display panel having a third surface; and a pressure sensitive adhesive disposed on one of the second surface and the third surface, wherein the display panel is attached to the second surface through the pressure sensitive adhesive.
2. The touch apparatus of Embodiment 1, wherein the pressure sensitive adhesive is a material being one selected from a group consisting of polyurethane, silicone, acrylic, and a combination thereof.
3. The touch apparatus of any one of Embodiments 1-2, further including an optical clear adhesive (OCA) disposed on the first surface.
4. The touch apparatus of any one of Embodiments 1-3, wherein the anti-shatter film includes: a plastic substrate having a fourth surface; and an optical clear adhesive disposed on the fourth surface.
5. A method for attaching a panel, including steps of: providing a touch panel; providing a functional film having a first surface and a second surface; attaching the first surface of the functional film to the touch panel; disposing a first pressure sensitive adhesive on the second surface; and attaching a display panel to the second surface through the pressure sensitive adhesive.
6. The method for attaching a panel of Embodiment 5, further including steps of: separating the first pressure sensitive adhesive from the display panel and the functional film; disposing a second pressure sensitive adhesive on the second surface; and attaching the display panel to the second surface through the second pressure sensitive adhesive.
7. The method for attaching a panel of any one of Embodiments 5-6, wherein the step of separating the first pressure sensitive adhesive from the display panel and the functional film includes steps of: separating the first pressure sensitive adhesive from the display panel; separating the first pressure sensitive adhesive from the functional film; and separating the functional film from the touch panel.
8. The method for attaching a panel of any one of Embodiments 5-7, further including a step of: disposing an optical clear adhesive on the first surface.
9. The method for attaching a panel of any one of Embodiments 5-8, wherein the functional film is an anti-shatter film.
10. A touch panel assembly, including: a touch panel; a display panel; a first adhesive layer attached to the touch panel and the display panel; and a functional film having a first surface and a second surface respectively attached to the touch panel and the display panel.
11. The touch panel assembly of Embodiment 10, wherein the first surface is attached to the touch panel through the first adhesive layer.
12. The touch panel assembly of any one of Embodiments 10-11, wherein the first adhesive layer is one selected from a group consisting of a pressure sensitive adhesive, an optical clear adhesive, an optical clear resin and a combination thereof.
13. The touch panel assembly of any one of Embodiments 10-12, wherein the functional film is an anti-shatter film.
14. The touch panel assembly of any one of Embodiments 10-13, wherein the second surface is attached to the display panel through a second adhesive layer.
15. A panel assembly, including: a first panel; a second panel; and a pressure sensitive adhesive attaching together the first panel and the second panel.
16. The panel assembly of Embodiment 15, wherein when the first panel is a touch panel, the second panel is one of a display panel and a protection panel.
17. The panel assembly of any one of Embodiments 15-16, further including: a third panel; and a second pressure sensitive adhesive attaching the second panel and the third panel, wherein the first panel is a display panel, the second panel is a touch panel, and the third panel is a protection panel.
18. A functional film, including: a substrate having a first surface and a second surface opposite to the first surface; and a first pressure sensitive adhesive having a first adhesion strength and attached to the first surface.
19. The functional film of Embodiment 18, further including a second pressure sensitive adhesive having a second adhesion strength and attached to the second surface, wherein the first adhesion strength and the second adhesion strength are different.
20. The functional film of any one of Embodiments 18-19, wherein the substrate is a material being one selected from a group consisting of polyester (PET), triacetyl cellulose (TAC), cycloolefin polymer (COP) and a combination thereof.

While the invention has been described in terms of what is presently considered to be the most practical and preferred embodiments, it is to be understood that the invention needs not be limited to the disclosed embodiments. On the contrary, it is intended to cover various modifications and similar arrangements included within the spirit and scope of the appended claims, which are to be accorded with the broadest interpretation so as to encompass all such modifications and similar structures.

What is claimed is:

1. A touch apparatus, comprising:
a touch panel;
an anti-shatter film having a first surface and a second surface opposite to the first surface, wherein the first surface is attached below the touch panel;
a display panel having a third surface; and
a pressure sensitive adhesive disposed on one of the second surface and the third surface, wherein the display panel is attached to the second surface through the pressure sensitive adhesive.

2. The touch apparatus according to claim 1, wherein the pressure sensitive adhesive has a material being one selected from a group consisting of polyurethane, silicone, acrylic, and a combination thereof.

3. The touch apparatus according to claim 1, further comprising an optical clear adhesive (OCA) disposed on the first surface.

4. The touch apparatus according to claim 1, wherein the anti-shatter film comprises:
a plastic substrate having a fourth surface; and
an optical clear adhesive disposed on the fourth surface.

5. A method for attaching a panel, comprising:
providing a touch panel;
providing a functional film having a first surface and a second surface;
attaching the first surface of the functional film to the touch panel;
disposing a first pressure sensitive adhesive on the second surface; and
attaching a display panel to the second surface through the pressure sensitive adhesive.

6. The method for attaching a panel according to claim 5, further comprising:
separating the first pressure sensitive adhesive from the display panel and the functional film;
disposing a second pressure sensitive adhesive on the second surface; and
attaching the display panel to the second surface through the second pressure sensitive adhesive.

7. The method for attaching a panel according to claim 6, wherein the separating of the first pressure sensitive adhesive from the display panel and the functional film comprises:
separating the first pressure sensitive adhesive from the display panel;
separating the first pressure sensitive adhesive from the functional film; and
separating the functional film from the touch panel.

8. The method for attaching a panel according to claim 5, further comprising:
disposing an optical clear adhesive on the first surface.

9. The method for attaching a panel according to claim 5, wherein the functional film is an anti-shatter film.

10. A touch panel assembly, comprising:
a touch panel;
a display panel;
a first adhesive layer attached to the touch panel and the display panel; and
a functional film having a first surface and a second surface respectively attached to the touch panel and the display panel.

11. The touch panel assembly according to claim 10, wherein the first surface is attached to the touch panel through the first adhesive layer.

12. The touch panel assembly according to claim 10, wherein the first adhesive layer is one selected from a group consisting of a pressure sensitive adhesive, an optical clear adhesive, an optical clear resin and a combination thereof.

13. The touch panel assembly according to claim 10, wherein the functional film is an anti-shatter film.

14. The touch panel assembly according to claim 10, wherein the second surface is attached to the display panel through a second adhesive layer.

15. A panel assembly, comprising:
a first panel;
a second panel; and
a pressure sensitive adhesive attaching together the first panel and the second panel.

16. The panel assembly according to claim 15, wherein when the first panel is a touch panel, the second panel is one of a display panel and a protection panel.

17. The panel assembly according to claim 15, further comprising:
a third panel; and
a second pressure sensitive adhesive attaching the second panel and the third panel, wherein the first panel is a display panel, the second panel is a touch panel, and the third panel is a protection panel.

18. A functional film, comprising:
a substrate having a first surface and a second surface opposite to the first surface; and
a first pressure sensitive adhesive having a first adhesion strength and attached to the first surface.

19. The functional film according to claim 18, further comprising a second pressure sensitive adhesive having a second adhesion strength and attached to the second surface, wherein the first adhesion strength and the second adhesion strength are different.

20. The functional film according to claim 18, wherein the substrate has a material being one selected from a group consisting of polyester (PET), triacetyl cellulose (TAC), cycloolefin polymer (COP) and a combination thereof.
